(19) United States
(12) Patent Application Publication
(10) Pub. No.: US 2007/0271017 A1
(43) Pub. Date: Nov. 22, 2007

(54) Weight dependent trailering switch

(76) Inventor: Farzad Samie, Franklin, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/436,313

(22) Filed: May 18, 2006

(51) Int. Cl. G06F 17/00

(52) U.S. Cl. 701/55

(57) ABSTRACT

A system and method for changing the shift pattern of a vehicle based on the weight of a trailer the vehicle is towing. The system can include a switch on the steering column or dashboard that can be engaged in predetermined increments, such as 1,000 pounds, to selectively change the shift pattern between a lighter weight trailer and a heavier weight trailer. Further, a load sensor can be provided on the hitch post for sensing the weight of the trailer, and a controller can automatically set the shift pattern based on the weight. Alternately, the system can provide a linear interpolation of the shift table to set the shift pattern based on weight.

### BACKGROUND OF THE INVENTION

1. Field of the Invention

This invention relates generally to a system and method for varying the shift pattern of a vehicle when the vehicle is towing a trailer and, more particularly, to a system and method for selectively changing the shift pattern of a vehicle towing a trailer, where the selection is made based on the weight of the trailer.

2. Discussion of the Related Art

Some vehicles, such as certain SUVs and full-size trucks, are built for towing trailers. These vehicles may include a switch, possibly on the steering column or dashboard, that can be switched to one position when the vehicle is not towing a trailer to provide a shift pattern for the transmission that provides the best performance and fuel economy based on the weight of the vehicle, and can be switched to another position when the vehicle is towing a trailer to provide another shift pattern more appropriate for the weight of the vehicle and the trailer. By switching the shift pattern when the vehicle is towing the trailer, the shifts will typically be made later so that more torque is provided for towing the weight of the trailer. However, when the vehicle is not towing the trailer, the shift pattern that provides better fuel economy and drivability would be more desirable.

To illustrate this, FIG. 1 is a graph with vehicle speed on the horizontal axis and percentage of throttle position on the vertical axis that shows up-shift lines for a full size truck with a 5.3 L V8 engine and 4-speed automatic transmission. Shift line 10 is for a shift from gear 1 to gear 2, shift line 12 is for a shift from gear 2 to gear 3 and shift line 14 is for a shift from gear 3 to gear 4 for the vehicle when it is not towing a trailer. Shift line 16 is for a shift from gear 1 to gear 2, shift line 18 is for a shift from gear 2 to gear 3 and shift line 20 is for a shift from gear 3 to gear 4 when the vehicle is towing a trailer.

For some vehicles, such as the ones mentioned above, the vehicle is able to tow trailers weighing up to 10,000 pounds. However, the known towing switches only switch between towing and no towing, and do not consider the weight of the trailer. Typically, the transmission shift pattern is set for the highest trailer weight that the vehicle is able to tow. Therefore, if the vehicle is towing a lighter trailer, say for example, 1,000 pounds, the shift pattern will not provide the best fuel economy and drivability no matter what position the switch in. Therefore, it would be desirable to change the shift pattern of the vehicle based on the weight of the trailer it was towing.

### SUMMARY OF THE INVENTION

In accordance wit h the teachings of the present invention, a system and method are disclosed for changing the shift pattern of a vehicle based on the weight of the trailer the vehicle is towing. The system can include a switch on the steering column or dashboard that can be engaged in predetermined increments, such as 1,000 pounds, to selectively change the shift pattern between a lighter weight trailer and a heavier weight trailer. Further, a load sensor can be provided on the hitch post for sensing the weight of the trailer, and a controller can automatically set the shift pattern based on the weight. Alternately, the system can provide a linear interpolation of the shift table to set the shift pattern based on trailer weight.

Additional features of the present invention will become apparent from the following description and appended claims taken in conjunction with the accompanying drawings.

### BRIEF DESCRIPTION OF THE DRAWING

FIG. 1 is a graph with vehicle speed on the horizontal axis and percentage of throttle position on the vertical axis showing a shift pattern for a vehicle that is towing a trailer and is not towing a trailer for up-shifts;

FIG. 2 is a graph with vehicle speed on the horizontal axis and percentage of throttle position on the vertical axis showing additional shift lines for a vehicle towing a trailer based on the weight of the trailer for up-shifts, according to the invention;

FIG. 3 is a plan view of a vehicle towing a trailer, and including a control system for setting the shift pattern of the vehicle based on the weight of the trailer, according to an embodiment of the present invention;

FIG. 4 is a graph with vehicle speed on the horizontal axis and percentage of throttle position on the vertical axis showing the shift pattern for a vehicle that is towing a trailer and is not towing a trailer for down-shifts; and

FIG. 5 is a graph with vehicle speed on the horizontal axis and percentage of throttle position on the vertical axis showing a torque converter control apply/release schedule for a vehicle that is towing a trailer and is not towing a trailer.

### DETAILED DESCRIPTION OF THE EMBODIMENTS

The following discussion of the embodiments of the invention directed to a system and method for selectively changing the shift pattern of a vehicle based on the weight of a trailer it is towing is merely exemplary in nature, and is in no way intended to limit the invention or its applications or uses.

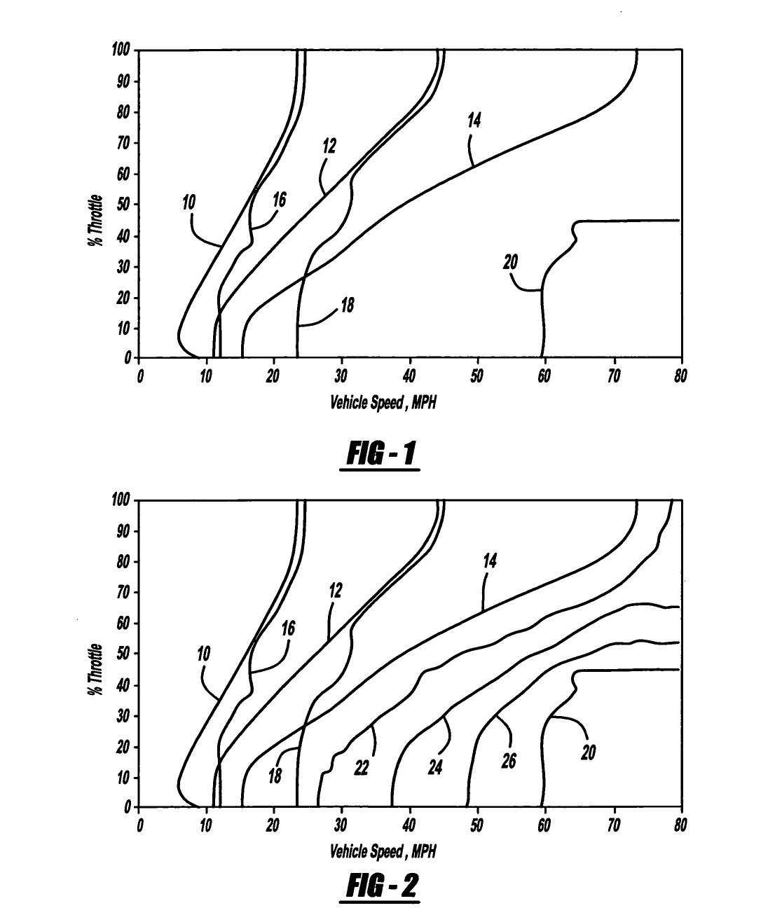

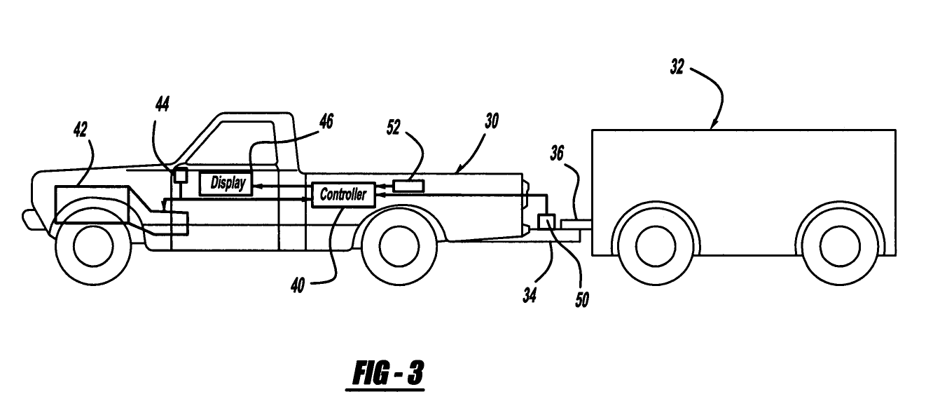

FIG. 2 is a graph with vehicle speed on the horizontal axis and percentage of throttle position on the vertical axis that shows the same shift lines that are in FIG. 1. According to the invention, a system is provided that selectively changes the shift pattern of the vehicle based on the weight of the trailer it is towing. To illustrate the invention, hypothetical up-shift lines for the shift between gear 3 and gear 4 are shown that could be used depending on the weight of the trailer. For example, the shift line 20 would be for a trailer at the upper towing weight limit of the vehicle, and shift lines 22, 24 and 26 could be used for the weight of a trailer as it increases to the maximum weight. If desirable, other shift lines can be provided between gears 1 and 2 and between gears 2 and 3 based on the weight of the trailer. Once the weight of the trailer is known, a controller can linearly interpolate the shift table to change the shifts for that weight, or can calculate a non-linear relationship based on vehicle calibration. The invention contemplates any suitable technique for determining the weight of the trailer, and making the appropriate control change in response thereto.

FIG. 3 is a plan view of a vehicle 30 towing a trailer 32. The vehicle 30 includes a hitch post 34 and the trailer 32 includes a tongue 36 to provide the connection between the vehicle 30 and the trailer 32 in the normal matter. A controller 40 on the vehicle 30 sets the shift pattern of the transmission 42 of the vehicle 30 based on the weight of the trailer 32. The weight of the trailer 32 can be provided by any suitable technique. For example, a switch 44 can be provided on the steering column of the vehicle 30 or the dashboard of the vehicle 30 which is selectively engaged by the vehicle operator. The switch 44 can be a multi-function switch where each time the vehicle operator engages the switch 44 it increases or decreases the weight for the trailer 32, such as in 1,000 pound increments, and sets the shift pattern accordingly. A display 46 can be provided that indicates what weight has been selected. In another embodiment, the switch 44 can set the weight of the trailer 32 for low, medium or high. Further, the switch 44 can be designed to provide a continuous selection of the weight of the trailer 32 from zero to a maximum towing capability of a vehicle. As long as the vehicle operator has a reasonable estimation of the weight of the trailer 32, he can selectively engage the switch 44 for that weight.

In another embodiment, a load cell 50 can be provided on the hitch post 34 that is able to measure the weight of the trailer 32 when it is connected thereto. The load cell 50 will provide a weight signal to the controller 40 of the measured weight, and the controller 40 can automatically set the shift pattern of the transmission 42 without any intervention from the vehicle operator. Load cells that can be used for this purpose are well known to those skilled in the art.

Additionally, the vehicle 30 can include a grade sensor 52 that provides an indication of whether the vehicle 30 is going uphill or downhill, and the controller 40 can use this information to also selectively change the shift pattern of the transmission 42. It is known in the art to calculate whether the vehicle 30 is going uphill or downhill without a grade sensor just by the performance of the engine using a suitable algorithm.

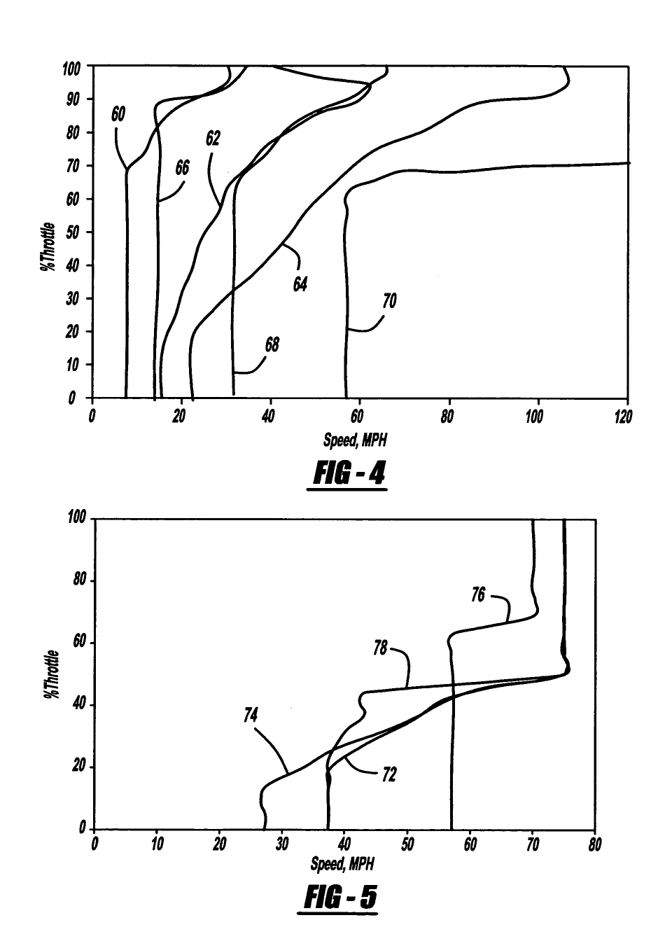

The discussion above refers to an up-shift pattern when the vehicle 30 is accelerating for different trailer weights. Other shift patterns could be provided for down-shifts and a torque converter control (TCC) apply/release schedule. For example, FIG. 4 is a graph with vehicle speed on the horizontal axis and percentage of the throttle position on the vertical axis showing down-shift lines for a full-size. Particularly, shift line 60 is for a down-shift from gear 2 to gear 1, shift line 62 is for a down-shift from gear 3 to gear 2 and shift line 64 is for a down-shift from gear 4 to gear 3 when the vehicle 30 is not towing the trailer 32. Shift line 66 is for a down-shift from gear 2 to gear 1, shift line 68 is for a down-shift from gear 3 to gear 2 and shift line 70 is for a down-shift from gear 4 to gear 3 when the vehicle 30 is towing the trailer 32. In the same manner as discussed above, the position of the down-shifts can be selectively changed based on the weight of the trailer 32.

FIG. 5 is a graph with vehicle speed on the horizontal axis and percentage of throttle position on the vertical axis showing a TCC apply/release schedule for a full-size truck. Graph line 72 shows the TCC apply/release line for gear 4 for the vehicle 30 when it is not towing the trailer 32 and graph line 74 shows the TCC apply/release line for gear 3 for the vehicle 30 when it is not towing the trailer 32. Graph line 76 is the TCC apply/release line for gear 4 when the vehicle 30 is towing the trailer 32 and graph line 78 is the TCC apply/release line for gear 3 for the vehicle 30 when it is towing the trailer 32. In the same manners discussed above, the position of the TCC apply/release schedule can be selectively changed based on the weight of the trailer 32.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A system for adjusting the shift pattern of a vehicle depending on the weight of a trailer that the vehicle is towing, said system comprising:
a device for indicating the weight of the trailer, said device providing a weight signal; and
a controller responsive to the weight signal, said controller varying the shift pattern of a transmission of the vehicle depending on the weight of the trailer.

2. The system according to claim 1 wherein the device is an operator switch that is activated by a vehicle operator, said operator switch being selectively activated to identify the weight of the trailer.

3. The system according to claim 2 wherein the switch is selectively activated to provide trailer weights between 1,000 and 10,000 pounds in 1,000 pound increments.

4. The system according to claim 2 wherein the switch is selectively activated to provide light, medium and heavy trailer weights.

5. The system according to claim 1 wherein the device is a load cell mounted to a hitch post connected to the vehicle, said load cell providing the weight signal in response to the trailer being attached to the hitch post.

6. The system according to claim 1 further comprising a display, said display displaying the weight selected by the device.

7. The system according to claim 1 further comprising a grade sensor, said grade sensor providing a grade signal to the controller indicative of the grade the vehicle is on, said controller adjusting the shift pattern of the transmission based on the grade signal and the weight signal.

8. The system according to claim 1 wherein the controller linearly interpolates a shift table of the vehicle between zero and a maximum weight that the vehicle can tow based on the weight signal.

9. The system according to claim 1 wherein the controller changes the shift pattern for both up-shifts and down-shifts.

10. The system according to claim 1 wherein the controller changes a torque converter control (TCC) apply/release schedule depending on the weight of the trailer.

11. A system for adjusting the shift pattern of a vehicle depending on the weight of a trailer that the vehicle is towing, said system comprising:
an operator switch that is activated by a vehicle operator to identify the weight of the trailer, said switch providing a weight signal;
a display for displaying the weight selected by the switch; and
a controller responsive to the weight signal, said controller varying the shift pattern of a transmission of the vehicle depending on the weight of the trailer, wherein the controller changes the shift pattern for both up-shifts and down-shifts.

12. A method for adjusting the shift pattern of a vehicle when the vehicle is towing a trailer, said method comprising:
determining the weight of the trailer; and
varying the shift pattern of a transmission of the vehicle based on the weight of the trailer.

13. The method according to claim 12 wherein varying the shift pattern of a transmission of the vehicle includes activating a switch to a switch position that sets the proper shift pattern for the determined weight of the trailer.

14. The method according to claim 13 wherein activating a switch to a switch position that sets the proper shift pattern includes activating the switch to set the shift pattern for a trailer weight between 1,000 and 10,000 pounds in 1,000 pound increments.

15. The method according to claim 13 wherein activating a switch to a switch position that sets the proper shift pattern includes activating the switch to set the shift pattern for a light, medium and heavy trailer weight.

16. The method according to claim 12 wherein determining the weight of the trailer includes using a load cell mounted to a hitch post connected to the vehicle that measures the weight of the trailer when it is attached to the hitch post.

17. The method according to claim 12 further comprising displaying the determined weight of the trailer.

18. The method according to claim 12 further comprising determining a grade that the vehicle is on, and wherein varying the shift pattern of a transmission of the vehicle includes varying the shift pattern of a transmission of the vehicle based on the grade and the weight of the trailer.

19. The method according to claim 12 wherein varying the shift pattern of a transmission of the vehicle includes interpolating a shift table between zero and a maximum weight that the vehicle can tow based on the weight signal.

20. The method according to claim 12 wherein varying the shift pattern of a transmission of the vehicle includes varying the shift pattern of a transmission of the vehicle for both up-shifts and down-shifts.
